(19) United States
(12) Patent Application Publication
(10) Pub. No.: US 2020/0191123 A1
(43) Pub. Date: Jun. 18, 2020

(54) LUMINOUS ELEMENT AND METHOD FOR ILLUMINATING A COMPONENT OF A WIND ENERGY INSTALLATION, AND COMPONENTS FOR A WIND ENERGY INSTALLATION AND WIND ENERGY INSTALLATION

(71) Applicant: Wobben Properties GmbH, Aurich (DE)

(72) Inventors: Stephan HARMS, Upgant-Schott (DE); Alexander HOFFMANN, Emden (DE); Jannes GROENHAGEN, Südbrookmerland (DE); Daniel VINKE, Aurich (DE); Felix SZYMKOWIAK, Uelsen (DE)

(21) Appl. No.: 16/324,027

(22) PCT Filed: Aug. 9, 2017
(86) PCT No.: PCT/EP2017/070252

§ 371 Date: Feb. 7, 2019

(30) Foreign Application Priority Data
Aug. 9, 2016 (DE) 10 2016 114 717.6

(51) Int. Cl. F03D 80/10; F03D 13/10; F21V 31/00; F21V 7/00

(52) U.S. Cl. CPC F03D 80/10; F03D 13/10; F21Y 2115/10; F21V 7/00; F21V 31/005

(57) ABSTRACT

A lighting element for illuminating a component of a wind power installation, in particular a rotor blade and/or a rotor and/or a tower and/or a nacelle. A component for a wind power installation, in particular a rotor blade and/or a rotor and/or a nacelle and/or a tower for a wind power installation. A wind power installation and a method for illuminating a component of a wind power installation. The lighting element comprises a lighting portion and a connection portion, wherein the connection portion is embodied and arranged to be connected in an interior of the component and the lighting portion is arranged and embodied to protrude from an opening of the component and the lighting portion is arranged and embodied to irradiate the component from which it protrudes.

### BACKGROUND

### Technical Field

The invention relates to a lighting element for illuminating a component of a wind power installation, in particular a rotor blade and/or a rotor and/or a tower and/or a nacelle. Further, the invention relates to a component for a wind power installation, in particular a rotor blade and/or a rotor and/or a nacelle and/or a tower for a wind power installation. Further, the invention relates to a wind power installation and a method for illuminating a component of a wind power installation.

### Description of the Related Art

Wind power installation and their components, such as rotor blades (in particular rotor blade tips), rotors (here within the meaning of an aerodynamic rotor) with a hub and one or more rotor blades, towers and/or nacelles, for example, require an illumination that can also be referred to as beaconing. This illumination or beaconing serves, in particular, for protecting air traffic in the vicinity of individual wind power installations or wind parks that consist of a plurality of wind power installations. Such an illumination or beaconing is particularly advantageous at night and/or in the case of poor visibility, although it may also be desired during the day, depending on the surroundings of the wind power installation and/or air traffic requirements. Existing solutions are known from WO 2006/077084 A1 or WO 2012/038296 A1, for example, in particular for the offshore sector. However, further improvements are desirable.

In the priority application in respect of the present application, the German Trade Mark and Patent Office has searched the following prior art: DE 10 2013 110 857 A1, DE 676 166 A, US 2005/0 052 869 A1.

### BRIEF SUMMARY

Provided is a lighting element and a method for illuminating a component of a wind power installation, and a component of a wind power installation and a wind power installation, which are improved in relation to existing solutions. In particular, provided is a lighting element and a method for illuminating a component of a wind power installation, and a component of a wind power installation and a wind power installation, which facilitate reliable and/or little bothersome illumination. Further, provided is a lighting element and a method for illuminating a component of a wind power installation, and a component of a wind power installation and a wind power installation, which facilitate and/or simplify servicing of and/or improve a large-area illumination of components of wind power installations.

According to a first aspect of the invention, provided is a lighting element for illuminating a component of a wind power installation, in particular a rotor blade and/or a rotor and/or a tower and/or a nacelle, comprising a lighting portion and a connection portion, wherein the connection portion is arranged and embodied to be connected in an interior of the component, and the lighting portion is arranged and embodied to protrude from an opening of the component, and the lighting portion is arranged and embodied to irradiate the component from which it protrudes.

On account of its embodiment with a lighting portion and a connection portion, the lighting element is suitable for protruding from an opening of a component of a wind power installation with the lighting portion, while the connection portion is arranged in an interior of the component and able to be connected there. Preferably, the opening of the component of a wind power installation is an assembly opening of a rotor blade of a wind power installation, wherein the assembly opening serves to receive a hoist when assembling the rotor blade on a wind power installation.

In particular, the lighting element can also be pushed through the opening in the component wall from an interior of the component such that the installation and/or servicing and/or a replacement of the lighting elements can be implemented in a simple and cost-effective manner, in particular also with little or no dependence on the weather conditions. Moreover, this also facilitates simple and cost-effective retrofitting of components of a wind power installation.

Preferably, the connection portion can be connected to supply lines required for the illumination in an interior of the component, for example by means of a plug. Preferably, the supply lines are connected to a central controller which assumes the actuation of the lighting elements. Preferably, this allows electronics within the lighting element to be dispensed with, as a result of which the lighting element itself once again becomes more cost-effective and simpler.

The component on which the lighting element is arranged preferably has a hollow interior, in particular an interior cavity or internal space, which is preferably walkable, for example by service staff. Further, supply lines and the like can preferably be guided in this interior of the component in order to supply the lighting element and/or other functional elements, for example with power.

By way of example, a functional element can be an element that fulfills a function that is advantageous for the operation of a wind power installation. Preferably, the functional element closes off an assembly opening of a rotor blade of a wind power installation and/or protrudes from the latter. Preferably, the functional element has at least one further function beyond closing off, preferably in sealing fashion, the assembly opening. By way of example, a functional element can be embodied as a sensor, for example for determining speed and/or humidity and/or light and/or temperature and/or weather data, and/or as a camera and/or as a vortex generator and/or as a lightning protection apparatus and/or as a heating apparatus.

A further peculiarity of the lighting element is that the lighting portion is arranged and embodied to irradiate a component from which it protrudes, preferably with electromagnetic radiation. Existing illumination devices, such as from WO 2006/077084 A1, for example, are designed to emit electromagnetic radiation into the surroundings of the wind power installation; i.e., they serve for direct perception of the illumination attached to the wind power installation or a component thereof from the outside (for example, from an aircraft) since the illumination radiates to the outside. By contrast, the lighting element provides for the component of the wind power installation, the lighting element protruding from the opening thereof, being irradiated by the lighting element. Consequently, the lighting portion of the lighting element is situated outside of the component or on the outer side thereof and is arranged and embodied to irradiate the component from the outside.

In this way, the component can reflect the electromagnetic radiation of the lighting element irradiating it. Thus, the irradiated component can be perceived from the outside (for example, from an aircraft), i.e., a significantly larger part of the wind power installation than only an illumination device itself.

Therefore, the lighting element is advantageous, in particular, in that there is not only point-wise, direct beaconing of the wind power installation and the components thereof, but there is beaconing of the component in the entire irradiated region as a result of irradiating the component and said entire irradiated region can consequently be perceived from the outside, for example from an aircraft.

The lighting element has particular advantages at locations of wind power installations at which it is necessary to closely approach the wind power installation with aircraft, in part as close as 50 m, or fly past the wind power installation at such a distance. By way of example, such a requirement arises in mountainous regions, in which wind power installations are increasingly erected. Large-scale circumnavigation of the wind power installation is often not possible on account of the topology, for example in narrow valleys, in particular in the case of rescue operations in the mountains, for example. Further, military aircraft, in particular, often travel at high speeds, which require appropriate beaconing of wind power installations. Here, the lighting element was found to be particularly advantageous since provision is made not only for a point-like illumination of the wind power installation by light sources radiating to the outside but also for a significantly larger region to be able to be made visible, for example for pilots, by the irradiation of the component. In particular, an illumination of the entire rotor and/or the rotor blades, in particular up to the blade tip, can be implemented in a simple and reliable manner using the lighting element. In this way, the wind power installation with the rotating rotor can be perceived as an overall obstacle and, in particular, the rotor diameter can also be identified by the pilot in order to facilitate safe navigation, even in close proximity and in the direct vicinity of the wind power installation.

A further advantage is that arranging the lighting element on the component to be irradiated provides a particularly efficient solution, particularly in view of the energy consumption as well. Preferably, at least one embodiment of the invention facilitates particularly short assembly distances, i.e., the arrangement of the lighting element close to the component or component region to be irradiated. As a result of arranging the lighting element at the component to be irradiated, there can be targeted irradiation of the component and/or scattering losses during the illumination can be reduced; this represents an advantage, particularly in the case of rotating components.

Here, the lighting portion is particularly preferably arranged and embodied to irradiate a region of at least 20%, preferably at least 30%, of the component and/or of the side of the component from which said lighting portion protrudes and/or on which the opening is arranged.

In a preferred embodiment, provision is made for the lighting portion to be arranged and embodied to irradiate the component from which it protrudes with electromagnetic radiation in the range of visible light, in particular yellow and/or red and/or white light, and/or in the range of infrared radiation.

Preferably, the range of visible light includes wavelengths from approximately 380 nm to 780 nm, corresponding to frequencies from approximately 789 THz to 384 THz. The range of yellow and/or red light preferably includes wavelengths from approximately 570 nm to 780 nm, corresponding to frequencies from approximately 525 THz to 384 THz. Here, in particular, white light is understood to be electromagnetic radiation in the range of visible light, in which a plurality of wavelength ranges are superposed.

Here, in particular, infrared radiation denotes the spectral range between 1 mm and 700 nm, corresponding to a frequency range from 300 GHz to 430 THz. A spectral range between 800 nm and 850 nm is particularly preferred.

Visible light is preferred for beaconing in order to ease navigation, also in visual flight. Irradiating the components with electromagnetic radiation in the infrared range is preferred since this type of irradiation is optically inconspicuous, usable independently of light conditions and, in particular, reliably identifiable, even for military aircraft.

Further, provision is preferably made for the lighting portion to have one or more light-emitting diodes. Light-emitting diodes for emitting visible light and/or infrared radiation are obtainable both relatively cheaply and with a high luminous intensity, and further have a long service life.

Further, the lighting portion preferably has an aerodynamic external form, for example a droplet form. By way of example, this can be realized by cladding the lighting portion. Such an aerodynamic external form is preferable, particularly when arranging lighting elements on movable components, in particular rotating components, of a wind power installation, in particular the rotor blades, in order to keep an increase of the air resistance as a result of arranging the lighting elements as low as possible.

Further, provision is preferably made for the lighting portion to have an external form that produces vortices and/or prevents or reduces a stall in an airflow. This, too, can be realized, for example, by corresponding cladding of the lighting portion. To this end, the lighting portion can have one or more vortex generators, for example.

A further preferred development is distinguished by virtue of the lighting element having a sealing portion between the lighting portion and the connection portion, said sealing portion being embodied and arranged to close-off the opening of the component from which the lighting element, in particular the lighting portion, protrudes in sealing fashion. Further, the lighting element can have a sleeve and/or one or more guide elements, for example, which ensure correct or desired positioning of the lighting element relative to the component from which the lighting portion of the lighting element protrudes and which should be irradiated by the lighting portion, for example also in relation to a desired or necessary emission angle.

The lighting element, in particular the sealing portion, preferably has an external diameter of at least or at most 100 mm, in particular a diameter of 120-130 mm, for example a diameter of 122 mm, or a diameter of at most 200 mm, and/or it is suitable for use in an opening with such a diameter.

In a further preferred embodiment, provision is made for the lighting element to be embodied as a bar-type lamp and/or plate-type lamp.

Further, provision is preferably made for the lighting portion to have a rounded and/or inclined emission surface. The emission surface is preferably transmissive for the electromagnetic radiation emitted by the lighting portion.

A further preferred development is distinguished by virtue of the lighting portion, in particular an emission surface of the lighting portion, protruding from the component by a predetermined distance, preferably by at least 10 cm, at least 20 cm, at least 30 cm, at least 40 cm, or at least 50 cm and/or at most 1 m.

Here, the lighting portion particularly preferably has an emission angle of 3° to 15°, in particular an emission angle of greater than 5° or greater than 10° and/or an emission angle of less than 15° or less than 12°.

A further preferred development is characterized by a lightning protection apparatus and/or a heating apparatus. This arrangement is preferred in order to prevent lightning damage and/or impairment by icing over. Since corresponding lines are guided in the interior of the component for the purposes of supplying the lighting element preferably in any case, these can advantageously also be used for the lightning protection apparatus and/or the heating apparatus.

The lighting element, in particular the lighting portion and/or the connection portion, can have a light source which emits electromagnetic radiation in the range of visible light and/or in the range of infrared radiation, for example in the form of an LED.

Further preferably, the lighting element, in particular the lighting portion, is arranged and embodied to deflect and/or reflect electromagnetic radiation in the range of visible light and/or in the range of infrared radiation. For instance, in this way, a light source can be arranged not on the lighting element itself but at a distance therefrom, for example in an interior of a component of a wind power installation. In this way, a particularly simple configuration of an illumination can be realized since the lighting element can be embodied merely as a passive, reflective component and a light source can be arranged at a distance from the lighting element, for example in the interior of the component of the wind power installation.

Preferably, the lighting element is free from electrical component parts, such as light sources. This is advantageous, inter alia, in that the risk of lightning damage can be reduced. By way of example, light sources can have electrically conductive materials. If the lighting element does not have a light source but merely serves as a passive lighting element, for example, and/or merely deflects and/or reflects radiation, light sources can be arranged in the interior of a component.

By way of example, the lighting element can have, in full or in part, an embodiment as a hollow bar or with a hollow-bar shape. A cross section orthogonal to a longitudinal axis of the lighting element can be round, oval, triangular or polygonal, for example, with straight and/or curved sides.

Preferably, the lighting element has a reflection surface. A reflection surface is preferably arranged in the interior of the lighting element, in particular in the interior of the hollow rod.

Preferably, the lighting element, in particular the lighting portion, can, in full or in part, be embodied from material which prevents or significantly reduces the passage of electromagnetic radiation in the range of visible light and/or in the range of infrared radiation. Further, the lighting element, in particular the lighting portion, preferably comprises a lighting region which is embodied as a recess and/or which consists of a material that allows the passage of electromagnetic radiation in the range of visible light and/or in the range of infrared radiation. By way of example, the lighting region can have a slot-shaped embodiment. In this way, the emergence of electromagnetic radiation in the range of visible light and/or in the range of infrared radiation can be focused onto the lighting region, as a result of which a particularly focused illumination can arise.

Preferably, the lighting element is embodied from a non-electrically-conductive material or has a non-electrically-conductive material, in particular making up a large part thereof. Preferably, the lighting element consists of a fiber-reinforced composite, in particular a fiber plastic composite, preferably having or consisting of plastics and glass fibers.

According to a further aspect of the invention, provided is a component for a wind power installation, in particular rotor blade and/or rotor and/or nacelle and/or tower for a wind power installation, comprising an opening, in particular an assembly opening, which serves to receive a hoist when assembling the rotor blade on a wind power installation, a lighting element as described above, the lighting portion of which protrudes from the opening, and/or a functional element, which protrudes out of the opening and/or closes off the opening.

By way of example, a functional element can be an element that fulfills a function that is advantageous for the operation of a wind power installation. Preferably, the functional element closes off an assembly opening of a rotor blade of a wind power installation and/or protrudes from the latter. Preferably, the functional element has at least one further function beyond closing off, preferably in sealed fashion, the assembly opening. By way of example, a functional element can be embodied as a sensor, for example for determining speed and/or humidity and/or light and/or temperature and/or weather data, and/or as a camera and/or as a vortex generator and/or as a lightning protection apparatus and/or as a heating apparatus.

Preferably, the opening is arranged in a wall of the component, which surrounds an inner cavity of the component. Preferably, the opening is a passage opening which connects the interior of a component with the surroundings of the component. Preferably, the opening has one or more guide and/or positioning elements, which serve to position a lighting element protruding from the opening relative to the component. In particular, the opening is preferably arranged and embodied in such a way that the lighting portion of the lighting element protruding from the opening can be arranged and/or aligned and/or positioned in such a way that the component is irradiated by the lighting portion.

Here, the component particularly preferably has two, three or more openings, in particular two, three or more assembly openings and two, three or more lighting elements as described above, and/or two, three or more functional elements. By way of example, the arrangement of at least one above-described lighting element on the pressure side and the arrangement of at least one above-described lighting element on the suction side is preferred in the case of rotor blades. By way of example, the arrangement of two or more above-described lighting elements at substantially the same height in relation to the longitudinal extent of the tower, preferably distributed around the circumference of the tower in equidistant fashion, is preferred in the case of a tower.

In particular, the opening is preferably an assembly opening, which serves to receive a hoist during the assembly of the rotor blade on a wind power installation.

A further preferred development of the component is distinguished by the opening being arranged in a region of the component that is walkable on the inside by service staff. This configuration is preferred as it facilitates a particularly simple and weather-independent manner for installation, service and replacement of lighting elements.

Further, provision is preferably made for the opening to be arranged in a region of the component that has a clear inner height of at least 60 cm, preferably at least 80 cm, in particular of at least 1 m. Such regions are preferred, in particular as walkable regions.

Further, the opening preferably has a diameter of at least or at most 100 mm, in particular a diameter of 120-130 mm, for example a diameter of 122 mm, or a diameter of at most 200 mm. In particular, being able to use the opening differently in the transportation and/or assembly state is preferable. By way of example, lifting point openings of rotor blades often have a diameter of 122 mm.

In a further preferred embodiment of the component, provision is made for the component to have a deflection element arranged and embodied to deflect radiation received from the lighting element in the direction of the component, in particular. By way of example, the deflection element can be embodied as an optical deflection element, e.g., a prism, and/or have an optical deflection element. In this way, the region of the component irradiated by the lighting portion can advantageously be enlarged.

Further, provision is preferably made for the component to have a lightning protection apparatus and/or a heating apparatus, which is arranged on the lighting element or in the direct vicinity thereof. Preferably, a region within a 1 m perimeter around the lighting element is understood to be the direct vicinity of the lighting element. A heating apparatus that is present on a component of the wind power installation in any case can be used as heating apparatus. As an alternative or in addition thereto, provision can be made of a separate and/or dedicated heating apparatus for the lighting element.

Provision is made for the component to be a rotor blade in a preferred embodiment.

Here, arranging the lighting element in a region of the rotor blade close to the hub is particularly preferred, with the region close to the hub preferably extending over no more than 50%, in particular over no more than 30%, for example over no more than 20%, of the longitudinal extent of the rotor blade. In particular, the region of the rotor blade root and a region adjoining the rotor blade root is understood to be a region of the rotor blade close to the hub. As a rule, the region of the rotor blade close to the hub, in particular, is still walkable by the service staff.

Further, provision is preferably made for the opening to be arranged or embodied in such a way that part of a hoist can be guided therethrough in the transportation state of the rotor blade. The opening can preferably be embodied as a lifting point opening. Therefore, the lighting element is preferably not yet arranged in the opening in the assembly and/or transportation state, and so the opening can still be used for other purposes, for example for fastening a hoist. Then, after completed assembly of the rotor blade on the rotor hub, one or more lightning elements are preferably installed in the openings. In this way, even existing wind power installations can be retrofitted easily and cost-effectively.

Further, the deflection element is preferably arranged between the lighting element and a rotor blade tip. The provision of a deflection element between lighting element and rotor blade tip is preferred, in particular in order to be able to reliably irradiate the longitudinal extent of the rotor blade right up to the blade tip. Preferably, the deflection element can be arranged in the outer third of a rotor blade that adjoins the blade tip.

Further, provision is preferably made for the lighting element to be arranged and embodied to irradiate the rotor blade up to the blade tip and/or up to the blade root. Preferably, the lighting element is embodied and arranged to irradiate the rotor blade in the direction of its longitudinal extent, in particular toward the blade tip and/or toward the blade root. Further, the lighting element is preferably arranged and embodied to irradiate the rotor blade toward leading edge and/or trailing edge.

Further preferably, the lighting element is arranged and embodied to irradiate the rotor blade, starting from a certain region around the lighting element. As a rule, the component is not irradiated within a certain perimeter around the lighting element. As a rule, this perimeter emerges from the emission angle, the distance by which the lighting portion protrudes from the component and the component geometry.

In a further preferred embodiment, provision is made for the component to be a rotor.

Here, the opening is particularly preferably arranged in a hub and/or a spinner of the rotor.

Further, provision is preferably made for the lighting element to be arranged and embodied to irradiate one or more rotor blades, preferably from the blade root onwards and/or up to the blade tip.

In a further preferred embodiment, provision is made for the component to be a nacelle.

Here, arranging and embodying the lighting element to irradiate one or more rotor blades, preferably from the blade root onwards and/or up to the blade tip, is particularly preferred.

In a further preferred embodiment, provision is made for the component to be a tower.

Here, the lighting element being arranged and embodied to irradiate the tower down to the foundations and/or up to the tip of the tower is particularly preferred.

According to a further aspect of the invention, provided is a wind power installation, comprising an above-described component, in particular a rotor blade and/or a rotor, and/or a nacelle and/or a tower.

According to a further aspect of the invention, provided is a method for illuminating a component of a wind power installation, comprising: providing an above-described lighting element, guiding the lighting portion out of an opening in a component of the wind power installation, in particular out of an opening in a rotor blade and/or a rotor and/or a nacelle and/or a tower, illuminating the component from which the lighting portion protrudes by the lighting portion.

The method for illuminating a component of a wind power installation further preferably comprises assembling a rotor blade on a wind power installation using at least one assembly opening in the rotor blade, and guiding the lighting portion out of the assembly opening. Thus, after assembling the rotor blade on the wind power installation, the assembly opening required to this end is preferably used for attaching the lighting element. A hoist situated in the assembly opening during the assembly is preferably removed before the lighting element and/or a functional element is attached.

According to a further aspect of the invention, provided is the use of an above-described lighting element for illuminating a component of a wind power installation, in particular a rotor blade and/or a rotor and/or a tower and/or a nacelle.

According to a further aspect of the invention, provided is a method for extending the functionality of a rotor blade of a wind power installation, comprising: assembling the rotor blade on a wind power installation using at least one assembly opening in the rotor blade, in particular for receiving hoist, attaching a functional element in the assembly opening.

According to a further aspect of the invention, provided is the use of an assembly opening of a rotor blade, which serves for receiving a hoist when assembling the rotor blade on a wind power installation, as an opening for receiving an above-described lighting element for illuminating a component of a wind power installation, in particular a rotor blade and/or a rotor and/or a tower and/or a nacelle, and/or for receiving a functional element, in particular during the operation of the wind power installation.

The component according to the invention and the method according to the invention and the respective possible developments have features or method steps which make these particularly suitable for being used with a lighting element according to the invention and the developments thereof. The lighting element and its respective possible developments, too, have features which make the lighting element particularly suitable for being used with a component according to the invention, a wind power installation according to the invention and/or the method according to the invention.

### BRIEF DESCRIPTION OF THE SEVERAL VIEWS OF THE DRAWINGS

In respect of the advantages, embodiment variants and configuration details of the respective aspects of the invention and the possible developments thereof, reference is made to the description relating to the corresponding features of the respective other aspects. Preferred embodiments of the invention are described in exemplary fashion on the basis of the attached figures. In detail:

FIG. 1 shows a schematic three-dimensional illustration of a wind power installation;

FIG. 2 shows a schematic three-dimensional illustration of an exemplary embodiment of a lighting element according to the invention;

FIG. 3 shows a schematic illustration of a lighting portion of a further exemplary embodiment of a lighting element according to the invention;

FIG. 4 shows a plan view of the lighting element according to FIG. 2 with aerodynamic cladding;

FIG. 5 shows a schematic illustration of part of a cross section through a rotor blade with a lighting element;

FIG. 6 shows a schematic illustration of part of a cross section through a rotor blade with a lighting element and a deflection element;

FIG. 7 shows a further schematic illustration of part of a cross section through a rotor blade with a lighting element;

FIG. 8 shows a schematic illustration of a longitudinal section through an embodiment of a rotor blade;

FIG. 9 shows a schematic illustration of a longitudinal section through a further embodiment of a rotor blade;

FIG. 10 shows a three-dimensional view of a further embodiment of a rotor blade;

FIG. 11 shows a broken three-dimensional view of part of the rotor blade according to FIG. 10;

FIG. 12 shows a schematic cross section of the rotor blade according to FIG. 10;

FIG. 13 shows a schematic cross section of a further exemplary embodiment of a rotor blade;

FIG. 14A shows a schematic cross section of a further exemplary embodiment of a rotor blade having lighting elements in a first arrangement;

FIG. 14B shows the rotor blade according to FIG. 14A having lighting elements in a second arrangement;

FIG. 15 shows a rotor blade having a lighting element with a reflection surface;

FIG. 16 shows a lighting element with a reflection surface; and

FIG. 17 shows a wind power installation with illumination from the spinner.

### DETAILED DESCRIPTION

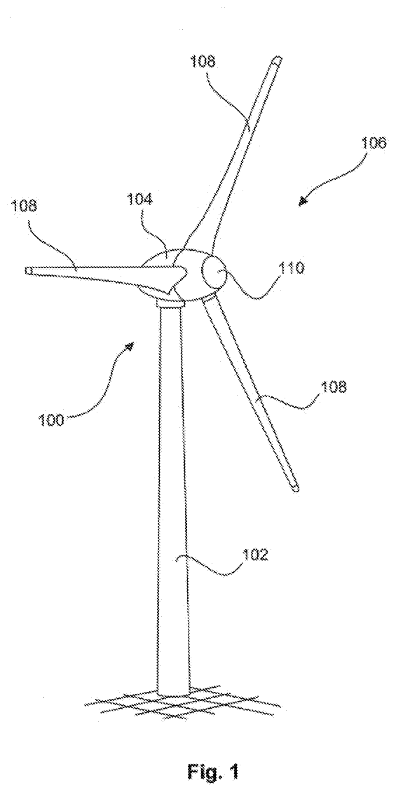

FIG. 1 shows a wind power installation 100 with a tower 102 and a nacelle 104. An (aerodynamic) rotor 106 with three rotor blades 108 and a spinner 110 is arranged on the nacelle 104. During operation, the rotor 106 is made to rotate by the wind and, as a result thereof, it drives a generator (with an electrodynamic generator rotor and a stator; neither of which are illustrated) in the nacelle 104. One or more components of the wind power installation 100, in particular one or more rotor blades 108, the rotor 106, the spinner 110, the nacelle 104 or the tower 102 have an opening, through which the lighting portion of a lighting element according to the invention protrudes in order to irradiate the component.

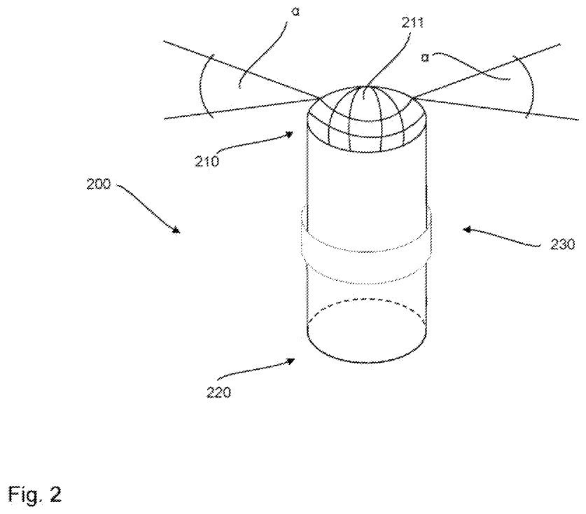

FIG. 2 shows a schematic three-dimensional illustration of an exemplary embodiment of a lighting element 200, having a lighting portion 210 and a connection portion 220. The lighting portion 200 has a rounded beam surface 211 and an emission angle α. A sealing portion 230 is arranged between the lighting portion 210 and the connection portion 220, said sealing portion being embodied and arranged to close off, in sealing fashion, the opening of the component from which the lighting element protrudes. Preferably, the opening is an assembly opening of a rotor blade, which serves to receive a hoist when assembling the rotor blade on a wind power installation.

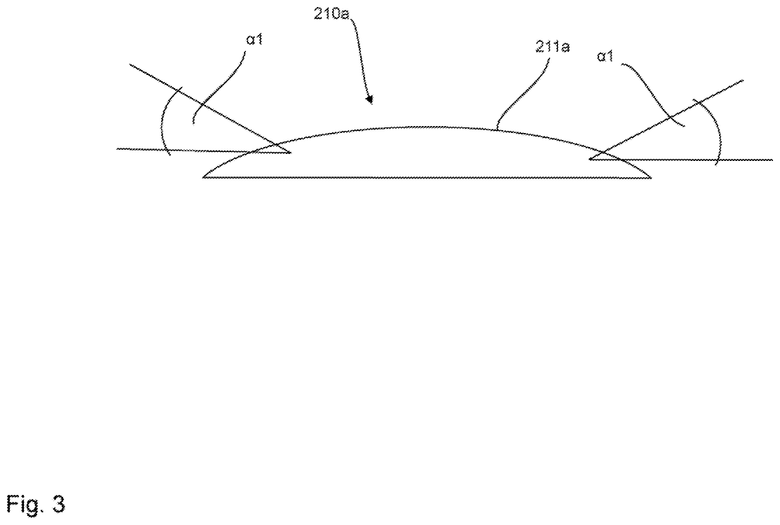

FIG. 3 shows a schematic illustration of a lighting portion 210a of a further exemplary embodiment of a lighting element. The lighting portion 210a likewise has a rounded beam surface 211a and an emission angle α1. However, the beam surface 211a is significantly flatter than the beam surface 211 of FIG. 2. An embodiment of a lighting element according to FIG. 3 can also be referred to as a plate-type lamp, while that of FIG. 2 can be referred to as a bar-type lamp.

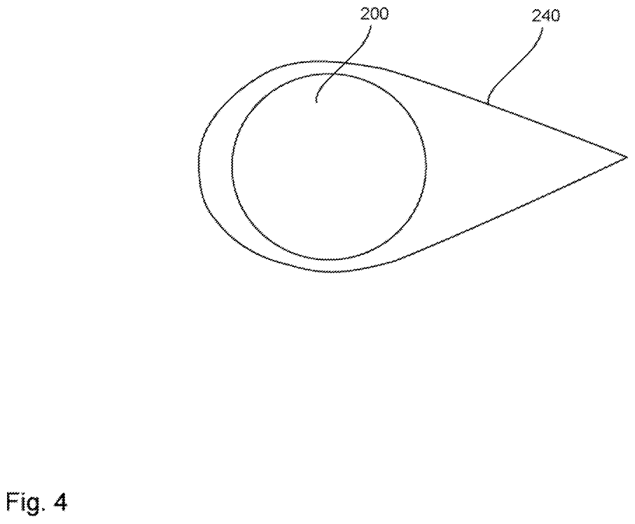

FIG. 4 shows a plan view of the lighting element 200 according to FIG. 2 with an aerodynamic cladding 240, and so an external form of the lighting element 200 in droplet form arises. Such an aerodynamic cladding 240 is preferable, particularly when lighting elements 200 are arranged on moving components, in particular rotating components, of a wind power installation, in particular the rotor blades, in order to minimize an increase of the air resistance as a result of arranging the lighting elements 200.

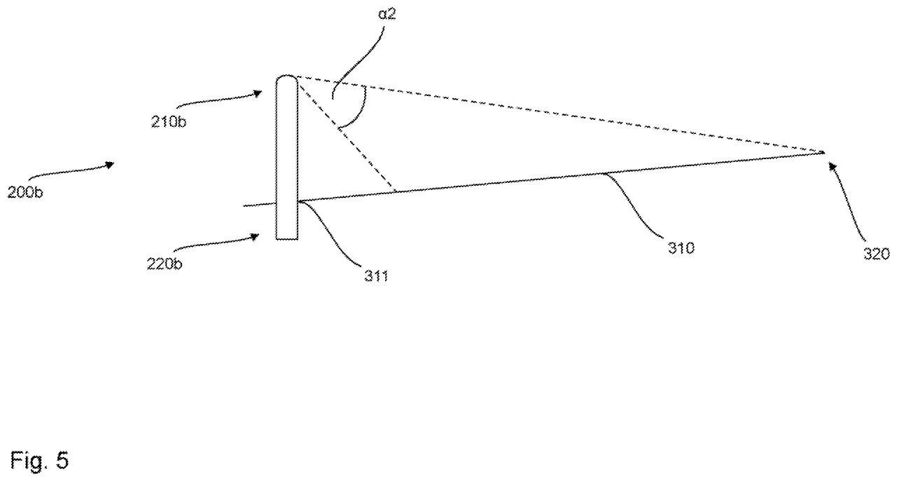

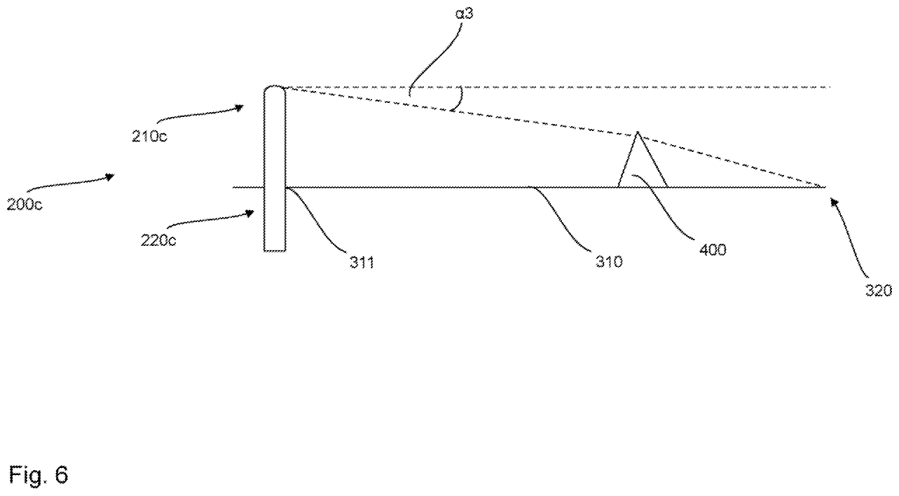

FIGS. 5 and 6 show a schematic illustration of part of a cross section through a rotor blade with a lighting element 200b, 200c. On its surface 310, preferably on the pressure and/or suction side, the rotor blade has an opening 311, through which the lighting element 200b, 200c is guided to the outside with its lighting portion 210b, 210c. The connection portion 220b, 220c of the lighting element 200b, 200c remains in the interior of the rotor blade.

The lighting elements 200b, 200c differ in respect of their emission angles α2, α3. While the lighting element 220b according to FIG. 5 has an emission angle α2, which allows irradiation of the surface 310 of the rotor blade up to the rotor blade tip 320, the emission angle α3 of the lighting element 200c according to FIG. 6 is different, and so, here, in the exemplary embodiment according to FIG. 6, a deflection element 400, for example in the form of a prism, is arranged on the surface 310 of the rotor blade, said deflection element being arranged and embodied to deflect radiation received from the lighting element 200c in the direction of the surface 310 of the rotor blade, in particular in the direction of the rotor blade tip 320.

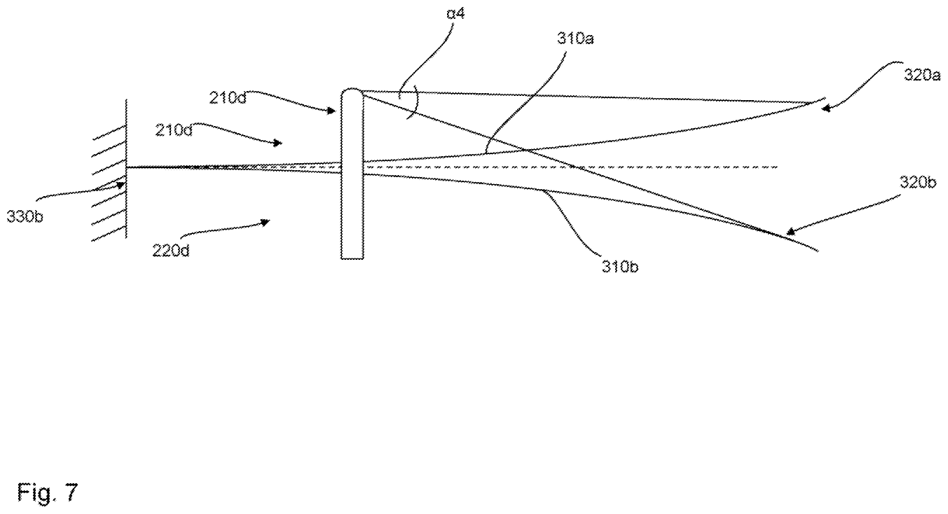

FIG. 7 shows a further schematic illustration of part of a cross section through a rotor blade having a lighting element 200d, comprising a lighting portion 210d and a connection portion 220d. The surface 310a, 310b of the rotor blade is illustrated once in the unloaded position (310a) and once in the position under full load (310b) in FIG. 7, the rotor blade tips 320a, 320b having different deflections in said positions in relation to the rotor blade root 330b. The emission angle α4 of the lighting element 200d is chosen in such a way that the surfaces 310a, 310b of the rotor blade are irradiated both in the unloaded state and in the situation under full load, particularly also in the region of the rotor blade tips 320a, 320b.

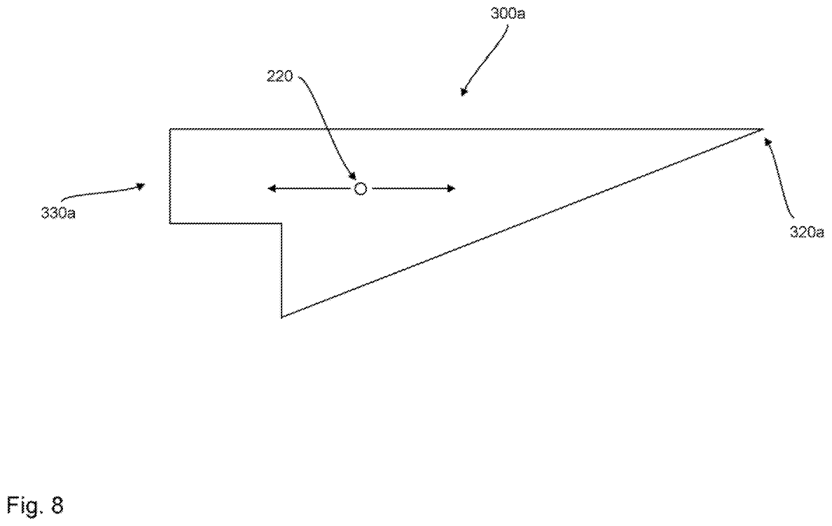

FIG. 8 shows a schematic illustration of a longitudinal section through an exemplary embodiment of a rotor blade 300a with a rotor blade tip 320a and a rotor blade root 330a. A lighting element 200 is arranged in the region of approximately one third of the longitudinal extent of the rotor blade 300a. The two arrows indicate that the lighting element 200 irradiates the surface of the rotor blade 300a both in the direction of the rotor blade root 330a and in the direction of the rotor blade tip 320a.

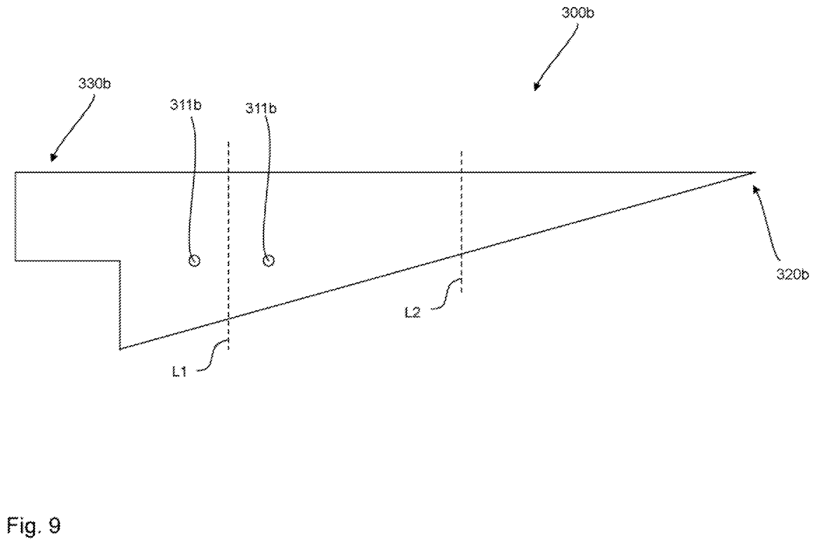

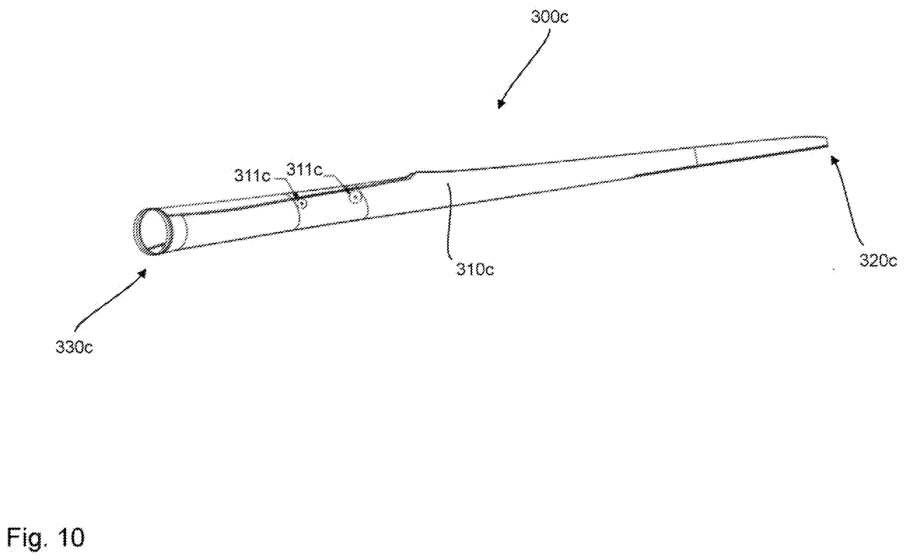

FIG. 9 shows a schematic illustration of a longitudinal section through a further embodiment of a rotor blade 300b having a rotor blade tip 320b and a rotor blade root 330b, as well as two openings 311b, in which lighting elements can be arranged. As may also be identified in FIGS. 10-12, the openings 311b are preferably arranged in the region of the lifter bar and, in particular, the openings 311b are preferably identical with the lifting point openings, which are used for transportation and assembly of rotor blades. After assembling the rotor blades on the rotor of the wind power installation, one or more openings 311b then can be used for illumination purposes with a lighting element. Therefore, existing wind power installations, too, can easily be retrofitted with a lighting element.

As a rule, the clear internal height of the rotor blade 300b in the region L1 is more than 1 m, and so the interior of the rotor blade in this region is easily accessible to service staff; this is particularly preferred for the installation, service and/or replacement of lighting elements in the openings 300b. Lighting elements are particularly preferably installed up to the region L2, which has such a minimum clear internal height that it can still be walked by service staff, in particular a clear internal height of at least 80 cm, in particular at least 1 m.

FIG. 10 shows a three-dimensional view of a further embodiment of a rotor blade 300c with a rotor blade tip 320c and a rotor blade root 330c. Here, too, the openings 311c in the surface 310c of the rotor blade 300c, which are preferred for arranging lighting elements, are identical to the lifting point openings provided for transportation and assembly.

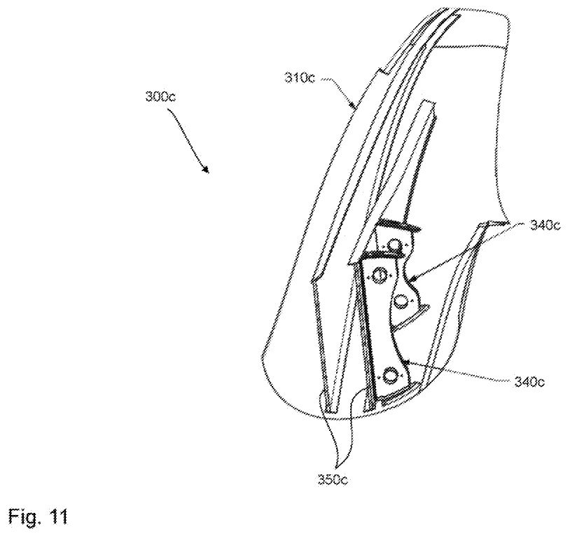

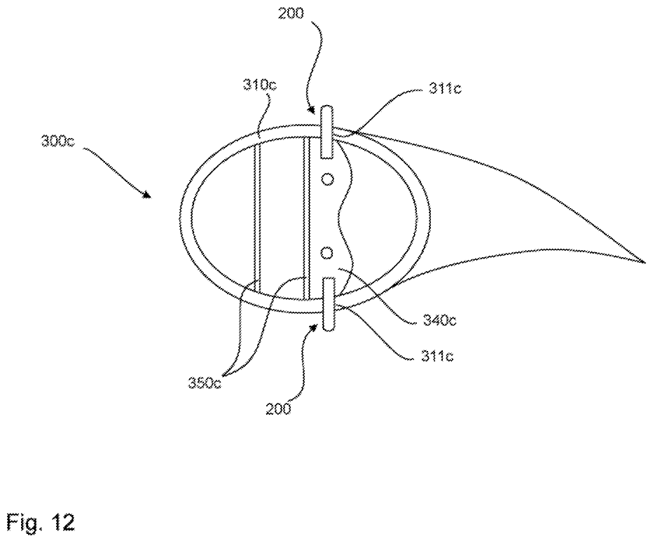

FIG. 11 shows a broken three-dimensional view of part of the rotor blade 300c according to FIG. 10; FIG. 12 shows a schematic cross section of the rotor blade according to FIG. 10. Here, it is possible to identify the lifter bars 340c, which are arranged on one of the spar webs 350c, wherein the openings 311c are preferably arranged in the region of the lifter bars 340c.

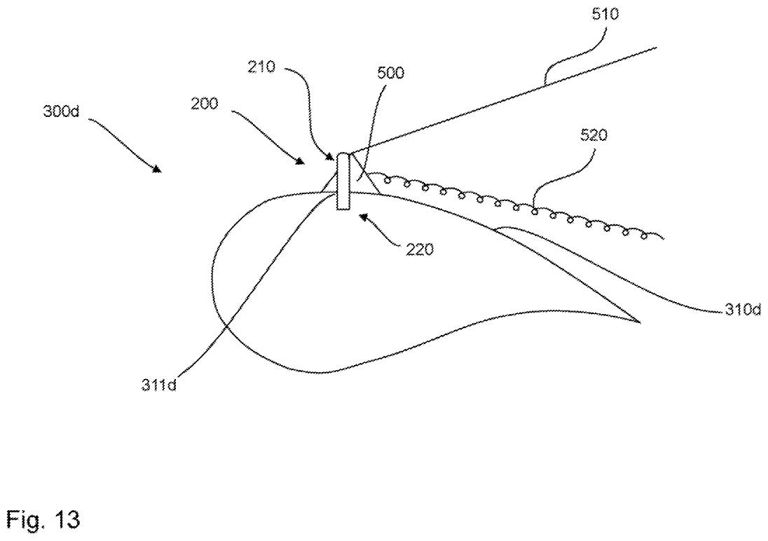

FIG. 13 shows a schematic cross section of a further exemplary embodiment of a rotor blade 300d. Here, too, an opening 311d is provided in the surface 310d of the rotor blade 300d, a lighting element 200 being guided through said surface in order to irradiate the rotor blade 300d from the outside, as described above. However, here, as a result of arranging a cladding 500, the lighting portion 210 further has an external form in the form of a vortex generator that produces vortices 520 and/or prevents or reduces a stall in an airflow 510.

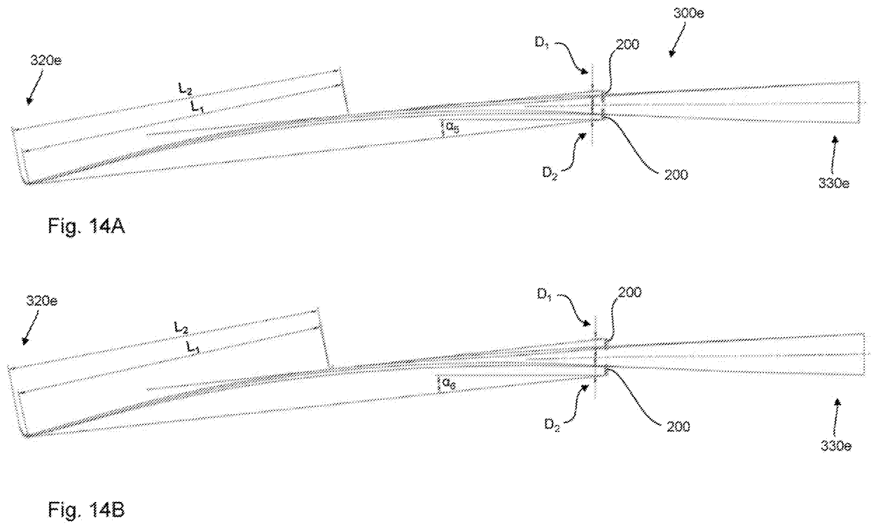

FIGS. 14A and 14B illustrate two further exemplary embodiments of a rotor blade 300e in a cross section, which extend from the rotor blade root 330e up to the rotor blade tips 320e. In both FIG. 14A, B, the rotor blades 300e are illustrated in the deflected state, in which the rotor blade tip 320e is clearly deflected from the longitudinal axis of the rotor blade 300e. This state can also be referred to as bending. Two lighting elements 200 are provided in both rotor blades 300e in each case, wherein respectively one lighting element is arranged on the suction side and one lighting element is arranged on the pressure side. In particular, the two rotor blades 300e differ in the arrangement of the lighting elements 200.

The lighting elements 200 of the rotor blade 300e in FIG. 14A, B are arranged in such a way that the lighting portions protrude from the opening in the surface of the rotor blade 300e by the distances D1 and D2. The arrangements of the lighting elements 200 of FIG. 14A, B differ in that the distances D1 and D2 of the arrangement according to FIG. 14B are greater than the distances D1 and D2 of the arrangement according to FIG. 14A. Further, at preferably 6.5°, the emission angle α5 is greater than the emission angle α6, which preferably has 6.1°. What emerges herefrom is that a region L1 and L2 (up to the angled tip) that adjoins the rotor blade tip 320e is no longer irradiated by the upper lighting elements 200 in FIGS. 14A, B. In cases in which the situation illustrated in FIG. 14A, B shows the blade pretensioning in the rest state, the bend of the rotor blade can reverse in the operating state and so a situation that is analogous or similar to that shown in FIG. 14A, B arises, in which, however, an opposite region adjoining the rotor blade tip 320e is no longer irradiated by the lower lighting elements 200 in FIG. 14A, B.

On account of the greater distances of the lighting portion from the surface of the rotor blade 320e in FIG. 14B, a shorter length L1 and L2 arises than for the arrangement of the lighting elements 200 according to FIG. 14A.

In principle, the arrangement of the lighting elements 200, in particular the distance by which the lighting portions protrude from the component surface, the emission angle and the component geometry, in particular also the pretensioning and maximum bend of rotor blades, for example, is preferably chosen in such a way that regions that are not irradiated, such as the regions L1 and L2, are minimized where possible. Allowing the lighting elements 200 on the suction and pressure side of the rotor plate to protrude different distances from the surface may also be preferable in the case of a nonsymmetric bend, for example of rotor blades in the pretensioned state and in the operating state. This renders it possible to take account of different bending in different situations.

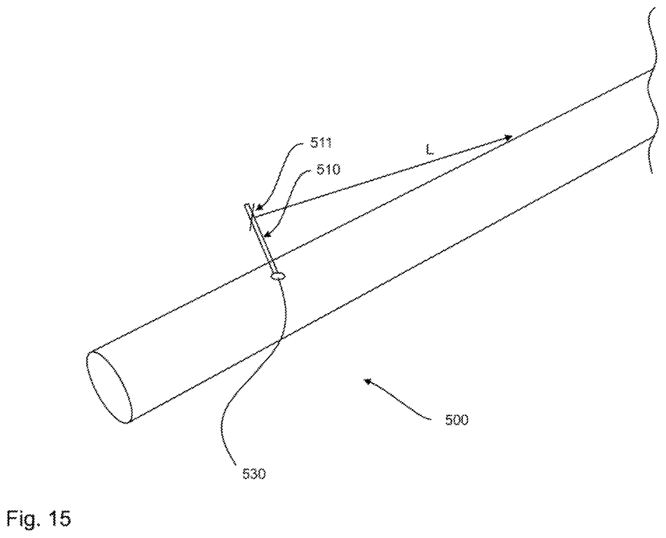

FIG. 15 shows a rotor blade 500 for a wind power installation having a lighting element 510. The lighting element 510 is guided out of an opening 530 from an interior of the rotor blade 500. The opening 530 is preferably an assembly opening, which serves to receive a hoist when assembling the rotor blade 500 on a wind power installation. FIG. 15 schematically indicates a reflection surface 511, which can be used to reflect and/or deflect electromagnetic radiation in the range of visible light and/or in the range of infrared radiation in order to irradiate the rotor blade in the direction of the arrow L, in particular in the direction of the rotor blade tip.

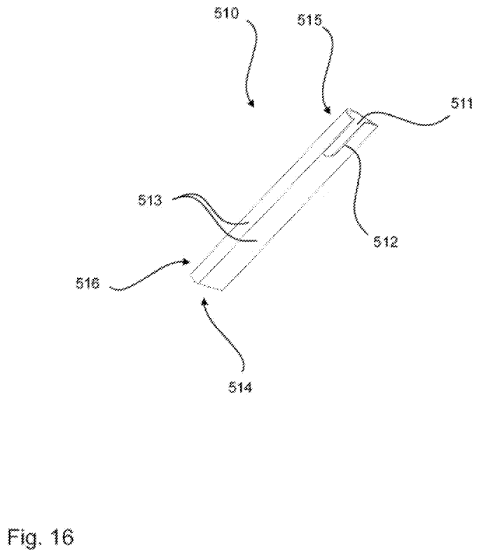

A possible configuration of the lighting element 510 is illustrated in FIG. 16. The lighting element 510 has a lighting portion 515 and a connection portion 516. The lighting element 510 can be connected, for example fastened, in the interior of a rotor blade 500, in particular in an opening 530, by way of the connection portion 516.

The lighting element 510 is free from electrical component parts, such as light sources; however, it is arranged and embodied to deflect and/or reflect electromagnetic radiation in the range of visible light and/or in the range of infrared radiation. To this end, the lighting element 510 has a reflection surface 511. The lighting element 510 is embodied as a passive, reflecting component; thus, for instance, a light source can be arranged at a distance from the lighting element, for example in the interior of the rotor blade. This is advantageous, inter alia, in that the risk of lightning damage can be reduced. Preferably, an infrared LED can be used as a light source.

Electromagnetic radiation in the range of visible light and/or in the range of infrared radiation, which is to be reflected and/or deflected by the reflection surface 511 of the lighting element 510, can enter into the interior of the lighting element 510 embodied as a hollow bar or with a hollow-bar shape, for instance through a front side 514. Preferably, the front side 514 is formed from a material that allows the passage of electromagnetic radiation in the range of visible light and/or in the range of infrared radiation. The sides 513 of the lighting element 510 can be formed from material that prevents or significantly reduces the passage of electromagnetic radiation in the range of visible light and/or in the range of infrared radiation.

Further, the lighting element 510, in particular the lighting portion 515, comprises a slot-shaped lighting region 512, which is embodied as a recess in this case. In this way, the emergence of electromagnetic radiation in the range of visible light and/or in the range of infrared radiation can be focused onto the lighting region, as a result of which particularly focused illumination may arise. As an alternative to the open configuration in the form of a recess, such a lighting region may also consist, for example, of a material that allows the passage of electromagnetic radiation in the range of visible light and/or in the range of infrared radiation.

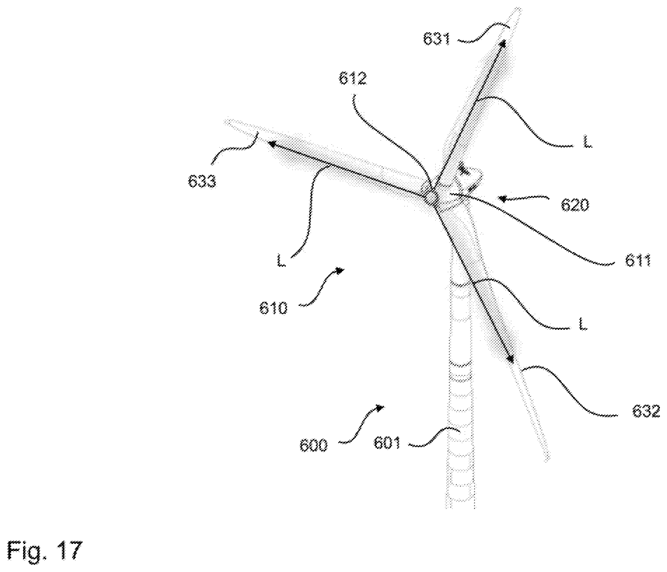

FIG. 17 illustrates a wind power installation 600 with illumination from the spinner 611. The wind power installation 600 has a tower 601 and a nacelle 620. An (aerodynamic) rotor 610 with three rotor blades 631, 632, 633 and a spinner 611 is arranged on the nacelle 620. During operation, the rotor 610 is made to rotate by the wind and, as a result thereof, it drives a generator (with an electrodynamic generator rotor and a stator; neither of which are illustrated) in the nacelle 620. In the example illustrated here, the spinner 611 has one or more openings, through which one or more light sources 612, preferably infrared LEDs, emit electromagnetic radiation, preferably in the range of infrared radiation, in the direction of arrows L in order, in particular, to irradiate the tips of the rotor blades 631, 632, 633.

1. A lighting element for illuminating a component of a wind power installation, the lighting element comprising:
a lighting portion and a connection portion,
wherein the connection portion is arranged and configured to be connected in an interior of the component,
wherein the lighting portion is arranged and configured to protrude from an opening of the component, and
wherein the lighting portion is arranged and configured to irradiate the component.

2. The lighting element as claimed in claim 1, wherein the lighting portion is configured to irradiate electromagnetic radiation in a range that includes at least one radiation range chosen from: visible light and infrared radiation.

3. The lighting element as claimed in claim 1, wherein the lighting portion has at least one of:
a light-emitting diode, and
an aerodynamic external form that is shaped as a droplet.

4. The lighting element as claimed in claim 1, wherein the lighting element is a bar-type lamp or plate-type lamp.

5. The lighting element as claimed in claim 1, characterized in that wherein the lighting portion has a rounded or inclined emission surface.

6. The lighting element as claimed in claim 1, wherein the lighting element is configured to reflect electromagnetic radiation in a range that includes at least one radiation range chose from: visible light and infrared radiation.

7. The lighting element as claimed in claim 1, wherein the lighting element has a reflection surface.

8. A component for a wind power installation, the component comprising:
an opening, configured to receive a hoist when assembling a rotor blade on the wind power installation, and
the lighting element as claimed in claim 1, wherein the lighting portion protrudes from the opening.

9. The component as claimed in claim 8, comprising:
a plurality of openings and a plurality of lighting elements,
wherein the plurality of openings are arranged in a region of the component that is accessible internally by service staff.

10. A wind power installation, comprising the component as claimed in claim 8.

11. A method for illuminating a component of a wind power installation, the method comprising:
providing the lighting element as claimed in claim 1;
guiding the lighting portion out of an opening in the component of the wind power installation; and
irradiating the component by the lighting portion.

12. The method as claimed in claim 11, comprising:
assembling a rotor blade on a wind power installation using an assembly opening in the rotor blade; and
wherein the guiding comprises guiding the lighting portion out of the assembly opening.

13. A method of using the lighting element as claimed in claim 1, the method comprising illuminating the component of the wind power installation by the lighting portion.

14. A method for extending a functionality of a rotor blade of a wind power installation, the method comprising:
assembling the rotor blade on a wind power installation using an assembly opening in the rotor blade, the assembly opening being configured for receiving hoist; and
attaching a functional element in the assembly opening.

15. A method of using an assembly opening of a rotor blade, which serves for receiving a hoist when assembling the rotor blade on a wind power installation, as an opening for receiving a lighting element as claimed in claim 1, wherein the lighting element is configured for illuminating a component of a wind power installation and for receiving a functional element during an operation of the wind power installation.

16. The component as claimed in claim 8, wherein the component is a rotor blade, an aerodynamic rotor, a tower, or a nacelle.

17. The component as claimed in claim 1, wherein the lighting portion has an external form that produces vortices and reduces a stall in an airflow.

18. The component as claimed in claim 1, wherein the lighting element has a sealing portion between the lighting portion and the connection portion, the sealing portion being configured and arranged to close off the opening of the component from which the lighting element protrudes in sealing fashion.

19. The component as claimed in claim 1, wherein an emission surface of the lighting portion protrudes from the component by a predetermined distance.

20. The component as claimed in claim 1, further comprising a lighting protection apparatus or a heating apparatus.
